(19) United States
(12) Patent Application Publication
(10) Pub. No.: US 2012/0242477 A1
(43) Pub. Date: Sep. 27, 2012

(54) Seatbelt violation alert system

(76) Inventor: Eli G. Rosenblatt, Flushing, NY (US)

(21) Appl. No.: 13/065,505

(22) Filed: Mar. 23, 2011

(51) Int. Cl. B60Q 1/26

(52) U.S. Cl. 340/463

(57) ABSTRACT

A seatbelt violation alert system having an exterior visual seatbelt violation indicator which includes an illumination device in electrical communication with a plurality of seatbelt sensors mounted to the seats of a vehicle. The seatbelt sensors include detectors that determine if a seatbelt is not being worn by a passenger in the vehicle. Upon determination that a passenger is not wearing the seatbelt, a signal is generated by the detector of the seatbelt sensor corresponding to the seat in which the passenger who did not fasten his seatbelt is seated that illuminates the exterior illumination device of the exterior seatbelt violation indicator. The exterior seatbelt violation indicator may be observable by law enforcement personnel.

### BACKGROUND OF THE INVENTION

1. Field of the Invention

This invention generally relates to automotive safety devices and more particularly relates to automotive restraining devices and warning systems.

2. Description of the Prior Art

Seatbelt use in motor vehicles has been shown to be an effective means of preventing and limiting injury to persons involved in motor vehicle accidents. Unrestrained operators and passengers of motor vehicles involved in accidents frequently suffer major injury due to their partial or complete ejection of the vehicle as well as general displacement and impacts within the vehicle. Generally, the severity of these injuries is easily lessened, if not prevented, by utilizing a seatbelt.

Often, operators of motor vehicles forgot to restrain their seatbelt or, alternatively, fail to properly restrain their seatbelt. Other operators refuse to fasten their seatbelts, placing their lives at risk as well as the well being of other travelers in proximity to their motor vehicle. Law enforcement is authorized to issue tickets and summons to motor vehicle operators failing to utilize restraining devices such as a seatbelt. Unfortunately, it is difficult for law enforcement officers to identify whether an operator is actually wearing a seatbelt due to the fast motion of motor vehicles. As such, enforcement of seatbelt laws is limited to routine traffic stops and low speed areas.

The present invention provides a novel seatbelt warning system that alerts both operators and law enforcement officers of improper seatbelt use.

### OBJECTS AND SUMMARY OF THE INVENTION

It is an object of the present invention to provide a seatbelt violation alert system for use in motor vehicles.

It is another object of the present invention to provide a seatbelt violation system that includes an exterior seatbelt violation indicator that informs third parties such as law enforcement officers of seatbelt violations in motor vehicles.

In accordance with one form of the present invention, a seatbelt violation system for use in motor vehicles includes an exterior seatbelt violation indicator having an exterior illumination device. The seatbelt violation system further includes a plurality of seatbelt sensors mounted to each seatbelt within a vehicle. The seatbelt sensors include a retraction detector or alternatively a detecting mechanism inside the seatbelt buckle, e.g., a switch or an optical detector, which determines whether the seatbelt is buckled and a weight detector to determine whether a seatbelt is being worn by a passenger. The seatbelt sensors are preferably in electrical communication with a microcontroller or alternatively a logic circuit, the microcontroller/logic circuit also being in electrical communication with the exterior illumination device.

In response to a signal generated by the detectors of the seatbelt sensors indicating a seatbelt is not being worn either by the driver or one of the passengers, the microcontroller generates a signal to periodically illuminate (i.e., flash or blink) the illumination device on the exterior seatbelt violation indicator to provide a signal to police or other law enforcement personnel that the driver and/or a passenger has failed to fasten his seatbelt in violation of the law.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 depicts the rear of a vehicle equipped with seatbelt violation indicator.

FIG. 2 depicts the rear of a vehicle equipped with seatbelt violation indicator wherein the letters SBV (Seat Belt Violation) appears on the indicator.

FIG. 3 depicts a gear mechanism wherein a secondary gear is utilized to detect whether the seatbelt is utilized.

FIG. 4 depicts the logical circuitry utilized to provide a lack of seatbelt use signal to a microcontroller/logic circuit.

FIG. 5 depicts the logical circuitry utilized to provide the lack of seatbelt use signal to cause the indicator on the rear of the vehicle to flash.

### DETAILED DESCRIPTION OF THE PREFERRED EMBODIMENTS

The present invention alerts the police or other law enforcement personnel that the driver and/or a passenger in a vehicle being driven has failed to fasten his seatbelt.

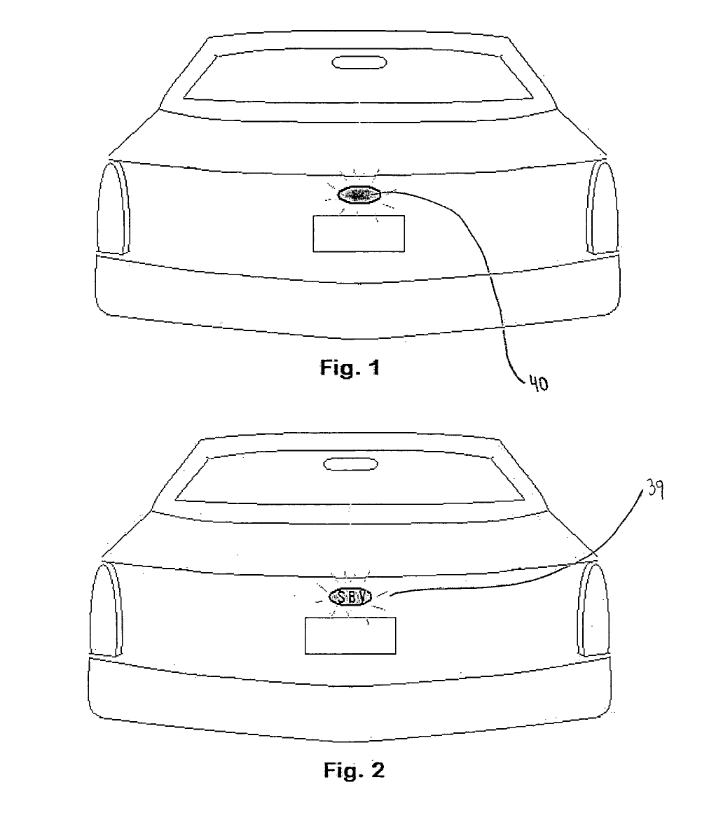

FIG. 1 depicts the rear of a vehicle equipped with seatbelt violation indicator 40 having a light (e.g., one or more light emitting diodes or one more incandescent bulbs 43). According to a preferred embodiment of the present invention, multiple light emitting diodes are used to provide a more intense light for better visualization and longevity. This light 43 could be blinking or solidly lit, but is preferably continuously illuminated to show that the light is working and has not been disconnected or tampered with, and only blinks or flashes when a seatbelt violation (a seatbelt is not being worn) is occurring. In a variation as depicted in FIG. 2, the rear of a vehicle may be equipped with seatbelt violation indicator 39 having the letters SBV (Seat Belt Violation) appear illuminated in a flashing manner on the indicator when a seatbelt is not worn.

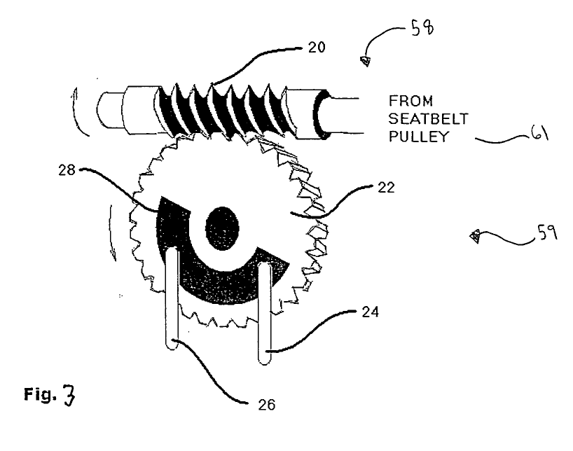

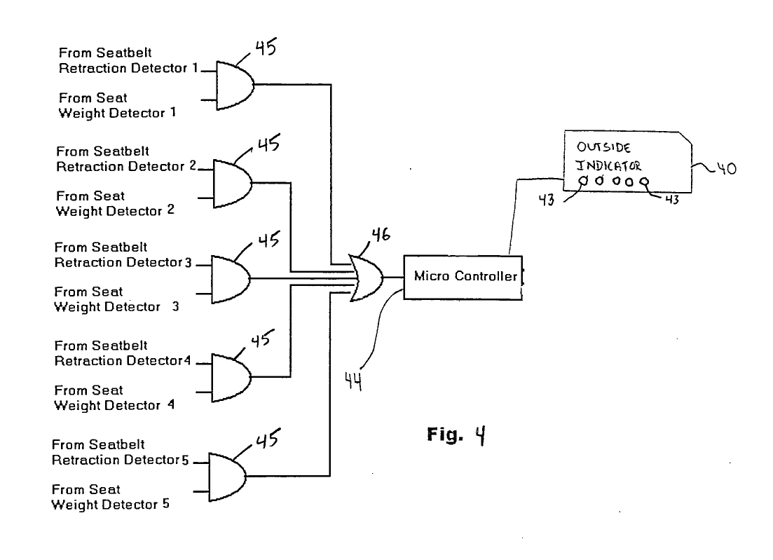

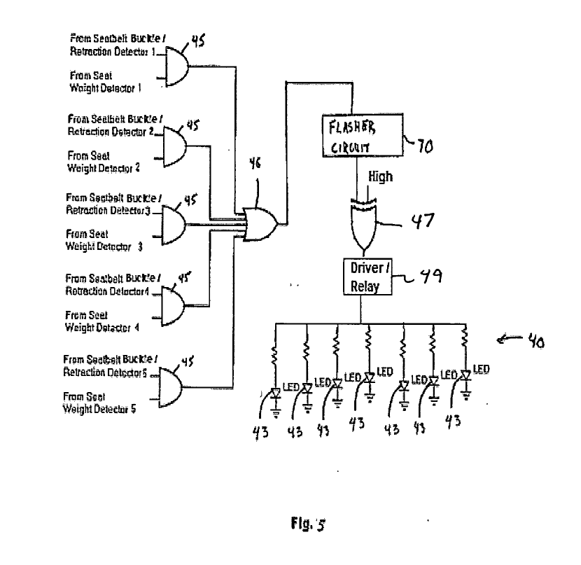

There are many methods to detect that the seatbelt is fastened or not. One possible method shown in FIG. 3 is to use a self winding seatbelt 59 in which, when the seatbelt is not utilized, the seatbelt totally retracts. Thus, a seatbelt retraction detector 58 can be accomplished by a spring loaded pulley 61 for the seatbelt strap. The pulley 61 is connected to a gear 20 which could be a regular or spiral gear. Gear 20 is turned by the pulley in which the seatbelt strap is wound. The secondary gear 22 is rotated as gear 20 is moved. Gear 22 includes a conductive strip 28. Brushes 24 and 26 are constantly in contact with the secondary gear 22. When the seatbelt is not utilized, the seatbelt strap is fully retracted and the brushes 24 and 26 simultaneously are in contact with conductive strip 28, the result of which the brushes 24 and 26 are shorted and which is used to provide the logic for the seatbelt not utilized signal. Accordingly, the seatbelt retraction detector 58 shown in FIG. 5 will generate a digital (or analog) signal, indicating whether or not the seatbelt to which it is coupled is being used.

FIG. 4 depicts the logic circuitry utilized to provide the lack of seatbelt use to a microcontroller 44. The lack of seatbelt use is established by sensing that the seatbelt is totally retracted (i.e., the signal from the seatbelt retraction detector) and the passenger presence is detected on the seat (i.e., a weight detector attached to each seat). The output signals from the seatbelt retraction detector 58 and weight detector for each seat in the vehicle are provided to the inputs of the respective AND gates 45, whose outputs are provided to the inputs of an OR gate 46, whose output is provided to the input of a microcontroller 44. The microcontroller could directly activate the rear indicator 40 to cause the rear indicator to flash when at least one of the driver and passengers is not wearing his seatbelt or, alternatively, the indicator 40 can be energized to flash by independent circuits.

FIG. 5 depicts another logic circuit which may be utilized to provide the lack of seatbelt use, i.e., when the seatbelt is retracted yet the presence of a passenger is sensed, in which the signal (a logic “1”) is provided on the output of the corresponding AND gate 45 to cause the output signal of the OR gate 46 to go to a logic “1”, which causes a flasher circuit 70 (which may be microcontroller 44 or another circuit) to drive the first input of Exclusive OR gate 47 which in turn drives a driver circuit or a relay 49 to turn the incandescent bulb or one or a plurality of light emitting diodes (LED) 43 of rear indicator 40 to flash or provide a solid light. The second input of the Exclusive OR gate 47 can be selected as High (logical level 1) or Low (logical level 0). Depending on the selection of logic level for the second input of Exclusive OR gate 47, when the seatbelts are worn appropriately, either the indicator light 43 is on or off whilst when at least one of the seatbelts is not worn the indicator light flashes.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A seatbelt violation alert system for use with a vehicle, the vehicle having an exterior surface, the vehicle having at least one seat and at least one seatbelt associated therewith, which comprises:
at least one seatbelt sensor, the seatbelt sensor having a detector for detecting if the at least one seatbelt is being worn by a person sitting in the at least one seat associated therewith, the detector generating a signal in response to the at least one seatbelt not being worn by a person; and
an exterior visual seatbelt violation indicator, the exterior seatbelt violation indicator being mounted on the exterior surface of the vehicle and being in electrical communication with the at least one seatbelt sensor, the exterior seatbelt violation indicator further including at least one exterior illumination device, the at least one exterior illumination device displaying a visual warning on the exterior surface of the vehicle in response to the signal generated by the detector of the at least one seatbelt sensor to indicate that the at least one seatbelt is not being worn by the person.

2. A seatbelt violation alert system as defined by claim 1, wherein the at least one exterior illumination device is one of solidly illuminated and periodically illuminated in response to the signal generated by the detector of the at least one seatbelt sensor such that the exterior seatbelt violation indicator indicates that the at least one seatbelt is not being worn by the person.

3. A seatbelt violation alert system as defined by claim 1, wherein the detector of the at least one seatbelt sensor further comprises:
a retraction detector for detecting if the at least one seatbelt is in a retracted state; and
a weight detector, the weight detector detecting the presence of a person in the at least one seat;
wherein, when the retraction detector detects that the at least one seatbelt is in a retracted state and the weight detector detects the presence of a person in the at least one seat, the detector of the at least one seatbelt sensor generates a signal, the at least one exterior illumination device of the exterior visual seatbelt violation indicator displaying a visual warning in response to the signal generated by the detector of the at least one seatbelt sensor indicating that the at least one seatbelt is not being worn by a person sitting in the at least one seat associated therewith.

4. A seatbelt violation alert system as defined by claim 1, which further comprises:
a flasher circuit operatively coupled to the exterior seatbelt violation indicator, the flasher circuit being responsive to the signal generated by the detector of the at least one seatbelt sensor and causing the at least one exterior illumination device of the exterior seatbelt violation indicator to illuminate periodically in response thereto to indicate that the at least one seatbelt is not being worn by the person.

5. A seatbelt violation alert system as defined by claim 4, wherein the flasher circuit causes the at least one exterior illumination device of the exterior seatbelt violation indicator to illuminate solidly when the at least one seatbelt is being worn by the person.

6. A seatbelt violation alert system for use with a vehicle, the vehicle having an exterior surface, the vehicle having a plurality of seats and a plurality of seatbelts associated therewith for restraining a plurality of persons, which comprises:
a plurality of seatbelt sensors, the plurality of seatbelt sensors having detectors for detecting if the plurality of seatbelts are being worn by the persons sitting in the plurality of seats associated therewith, the detector of each seatbelt sensor of the plurality of seatbelt sensors generating a signal in response to the seatbelt not being worn by a person; and
an exterior visual seatbelt violation indicator, the exterior seatbelt violation indicator being mounted on the exterior surface of the vehicle and being in electrical communication with the plurality of seatbelt sensors, the exterior seatbelt violation indicator further including at least one exterior illumination device, the at least one exterior illumination device being one of solidly illuminated and periodically illuminated in response to at least one signal generated by the detector of at least one seatbelt sensor of the plurality of seatbelt sensors such that the exterior seatbelt violation indicator indicates that a seatbelt is not being worn by a person in the vehicle.
